(19) United States
(12) Patent Application Publication
(10) Pub. No.: US 2002/0158529 A1
(43) Pub. Date: Oct. 31, 2002

(54) Ferrofluid pivot bearing

(76) Inventors: Yulan Liu, Singapore (SG); Cheng Hia Kang, Singapore (SG); Terutoshi Komatsu, Chiba-City (JP)

Correspondence Address: MESMER & DELEAULT, PLLC, 41 BROOK STREET, MANCHESTER, NH, 03104, US

(21) Appl. No.: 09/973,392

(22) Filed: Oct. 9, 2001

(30) Foreign Application Priority Data
Apr. 24, 2001 (JP) 2001-125887
May 29, 2001 (JP) 2001-160349

(51) Int. Cl. H02K 7/09

(52) U.S. Cl. 310/90.5

(57) ABSTRACT

A ferrofluid pivot bearing has a shaft, at least a first magnetic element fixedly attached to the shaft, a housing containing the magnetic element such that the housing is rotatable about the magnetic element, and a quantity of magnetic fluid within the housing.

This application claims the benefit of Japanese Patent Application No. 2001-125887, filed Apr. 24, 2001, and Japanese Patent Application No. 2001-160349, filed May 29, 2001.

### BACKGROUND OF THE INVENTION

1. Field of the Invention

The present invention relates generally to bearings used to support rotatable assemblies. Particularly, the present invention relates to bearings used in hard disk drives. More particularly, the present invention relates to pivot bearings used in hard disk drives.

2. Description of the Prior Art

The extensive data storage needs of modern computer systems require large capacity data storage devices. A common storage device is the rotating magnetic disk drive. A disk drive typically contains one or more flat disks that are rigidly attached to a common spindle. The disks are stacked on the spindle parallel to each other and spaced apart so that they do not touch. The disks and spindle rotate in unison at a constant speed provided by a spindle motor. A disk drive incorporates a solid disk-shaped substrate with a center hole to accommodate the spindle. The substrate is coated with a thin layer of magnetizable material. Data is recorded on the surfaces of the disks in the magnetizable layer.

The recorded data is usually arranged in circular concentric tracks, which are further divided into a number of sectors. Each sector forms an arc of a track and all the sectors of a track form a circle. A movable actuator positions a transducer head adjacent the data surface to read or write data. Most disk drives now being produced use a rotary actuator that pivots about an axis. There is one transducer head for each disk surface designed to contain data. The transducer head is an aerodynamically-shaped block of material on which is mounted a magnetic read/write transducer. The block travels above the surface of the disk at an extremely small distance as the disk rotates. The close proximity to the disk surface is critical in enabling the transducer to read from or write to the data in the magnetizable layer.

A rotary actuator typically includes a solid block near the pivot axis having comb-like arms extending toward the disk, a set of thin suspensions attached to the arms, and an electromagnetic motor on the opposite side of the axis. The transducer heads are attached to the suspensions, one head for each suspension. The actuator motor rotates the actuator to position the head over a desired data track. Once the head is positioned over the track, the constant rotation of the disk will eventually bring the desired sector adjacent the head allowing the data to be read or written.

Conventionally, the rotatable disk spindle assembly and the rotary actuator assembly are supported by sets of ball bearings housed in annular races. Typically, there are two sets of bearings for the disk spindle and two for the rotary actuator. Each set supporting a particular assembly that is axially separated from the other to provide greater stability. Multiple balls, however, generate significant bearing drag and mechanical hysteresis.

One such problem is contamination from the bearing grease caused by evaporation or migration. This contamination may affect the head/disk interface. The head and disk may be damaged by the evaporated substance from the bearing. Another problem relates to the movement of the pivot bearing. The rotatable actuator moves within an angle of about 30 degrees of repetition. During this movement, especially at startup and turning, pulse-like force is generated by the ball bearings in the pivot. This force is then transmitted to the read/write heads as high frequency wave noise. This affects precise head positioning and is recognized as error of the servo track signal. This results because of poor damping effect of the ball bearings in the pivot.

Yet another problem is that the balls in the ball bearing have a tendency to be fretted by poor lubrication during the small repetitive movement of the pivot bearing. Further, the performance of ball bearings depends highly on the accuracy of the individual parts such as the balls and the inner/outer races.

Although the oil bearing is currently being developed as an improved alternative to the ball bearing for spindle motor applications, it may not be applicable to the pivot bearing due to the pivot bearing's small repetitive movements within a 30 degree arc of movement. The oil pressure generated by this small repetitive movement is insufficient to support the head arm assembly. Furthermore, the oil itself may create oil contamination problems if not sealed properly.

A typical, prior-art ball bearing is shown in FIG. 1. An actuator (not shown) is typically mounted to a motor-driven pivot shaft 4 of a ball-bearing pivot 1, which rotates the heads on the actuator to various locations on the disk (not shown). Shaft 4 is surrounded by a housing 3. Typically, two ball bearings 2 are used to support shaft 4 within housing 3. To reduce the likelihood of emitting oil vapor and aerosol droplets of grease that are potential source of contamination in the disk drive, prior art devices have used several different types of seals to seal the pivot bearings. One type of bearing seal, known as a ferrofluid seal, is practically impermeable to emissions from bearings.

U.S. Pat. No. 6,229,676 B1 (2001, Walter Prater) discloses a ferrofluid seal for a hard disk drive actuator bearing. The ferrofluid seal has two circular plates that are axially spaced apart about a nonmagnetic pivot shaft of the actuator. The plates are parallel and in close proximity to one another. The upper plate is made of magnetically-conductive steel and is mounted to a stationary sleeve, which surrounds the shaft. The lower plate is mounted to the shaft and has an annular magnet with pole pieces on an upper surface. A magnetic ferrofluid is located between the magnet and the upper plate to complete the magnetic circuit and form a seal.

A disadvantage of using such a ferrofluid seal with conventional pivot bearings is the incorporation of additional parts to the actuator bearing assembly. Additional parts include higher attendant material and labor costs. Further, the ball bearings still have the problems associated with ball bearing pivot bearings previously enumerated.

With the development of faster and more powerful computer systems, there has been a corresponding demand for improved storage devices. Typically, these demands translate to a desire for reduced cost, increased data capacity, increased speed at which disk drives operate, reduced electrical power consumption by the disk drives, and increased resilience of the disk drives in the presence of mechanical shock and other disturbances.

Therefore, what is needed is a pivot bearing that is simple to construct. What is further needed is a pivot bearing that is capable of providing contamination control, high damping effect and noiseless performance. What is still further needed is a pivot bearing that is substantially free of fretting wear. What is yet further needed is a pivot bearing that allows higher precision in repetitive, positional performance that is capable of contributing to higher memory densities of hard disk drives.

### SUMMARY OF THE INVENTION

It is an object of the present invention to provide a ferrofluid pivot bearing that is capable of providing contamination control. It is another object of the present invention to provide a ferrofluid pivot bearing that provides high damping effect and substantially noiseless performance. It is a further object of the present invention to provide a ferrofluid pivot bearing that is substantially free of fretting wear. It is yet another object of the present invention to provide a pivot bearing that allows higher precision in repetitive positional performance when the repetitive positional performance is limited to movement within an acute angle. It is also another object of the present invention to provide a ferrofluid pivot bearing that provides enough stiffness to support an actuator head and arm by using the magnetic levitation phenomenon provided by the combination of ferrofluid, magnet, magnetic yokes and nonmagnetic housing.

The present invention achieves these and other objectives by providing a ferrofluid pivot bearing comprising a shaft, at least a first magnetic element fixedly attached to the shaft, a housing containing the at least a first magnetic element in which the housing is rotatable about the at least a first magnetic element, and a quantity of magnetic fluid inside the housing between the first magnetic element and the inside surface of the housing. Optionally, a magnetic coating over at least a portion of the outside surface of the housing is provided. The shaft is made from a non-magnetic material. The first magnetic element has a cylindrical shape with a central hole sized to receive the shaft in a sliding fit. The first magnetic element is fixed to the shaft to prevent its rotation about the shaft. Generally, the first magnetic element is a magnet.

An oil repellent material may be used to help prevent migration of the ferrofluid out of the housing. It is optionally applied to an area of the shaft that corresponds to the ends of the housing, to an area of the ends of the housing that correspond to the shaft, or to both corresponding areas of the shaft and the ends of the housing. The oil repellent material is a material, preferably a fluoropolymer, that reduces the wetting ability of the ferrofluid between the shaft and the ends of the housing.

The magnetic coating over at least a portion of the outside surface of the housing is generally at least one of nickel, iron and nickel-iron alloy. The magnetic coating reduces the magnetic flux leakage from the pivot bearing. Excessive magnetic flux leakage in a hard disk drive has an adverse effect on the operation of the read-write heads of the disk drive. The magnetic coating may cover all of the major outside surfaces of the housing including the top and bottom surfaces, or it may cover only the circumferential surface of the housing. The coating may be disposed on the housing by plating, deposition or spattering.

It is the magnetic levitation phenomenon of the present invention that allows the present invention to work without the use of ball bearings. With the use of one or more magnetic elements, the magnetic fluid and the non-magnetic housing, the magnetic flux density generates sufficient stiffness within the pivot bearing to support the head arm actuator of a disk drive even when the actuator is limited to an angle of thirty degrees as a repetitive movement operation. The combination of components in the present invention also provides contamination control, high damping effect and noiseless performance. The use of ferrofluid seal technology creates a liquid, hermetic seal that prevents the escape of potential contaminants from inside the housing. The viscosity of the ferrofluid and the fact that, unlike the prior art ball-bearing pivot, the magnet of the present invention does not contact the housing directly provides the high damping effect and contributes to the noiseless operation of the present invention.

Further, the use of magnetic fluid and at least one magnetic element provides a non-fretting characteristic to the ferrofluid pivot bearing. Because the prior art ball-bearing pivot operates on the principal that the ball bearings ride on the shaft, surface damage may result. This surface damage, called fretting corrosion, is caused by the close contact under pressure of the two surfaces, one or both of which are metals, and subjected to a slight relative motion. The magnetic phenomenon of the present invention coupled with the magnetic fluid in the gap between the magnetic element and the housing provides a pivot bearing that lacks the close contact of the two surfaces and, thus, helps prevent fretting corrosion.

In use, both the prior art pivot bearing and the present invention generate vibration. However, the present invention generates a much lower vibration than the frequency peaks produced by the ball bearing pivot of the prior art. The viscosity of the ferrofluid coupled with the levitation phenomenon provides the damping effect previously described. This reduces the frequency wave of repetition movement up to several kilohertz (kHz). The frequency wave peaks generated by the prior art ball-bearing pivot may be adverse to the positioning of read/write heads.

These characteristics allow the ferrofluid pivot bearing of the present invention to operate within a wide range from a large stroke repetition to a small stroke repetition, which is extremely useful for tracking purposes in hard disk drive read/write operations. These characteristics also allow the pivot bearing of the present invention to have high precision performance regarding the repetitive movement of hard disk drive actuator arms. Having a high repetitive movement performance contributes to the capability of using higher memory densities in hard disk drives or any high-density removable and/or floppy disk drives.

### BRIEF DESCRIPTION OF THE DRAWINGS

FIG. 1 is a cross-section view of a prior art pivot bearing.

FIG. 2 is a cross-sectional view of one embodiment of the present invention showing three magnetic elements with four bearing elements attached to a shaft in a housing with a magnetic layer disposed on its circumference.

FIG. 3 is a cross-sectional view of a second embodiment of the present invention showing one magnetic element with two bearing elements attached to a shaft in a housing with a magnetic layer disposed on its circumference.

FIG. 4 is a cross-sectional view of a third embodiment of the present invention showing three magnetic elements with two bearing elements attached to a shaft in a housing with a magnetic layer disposed on all of the outside major surfaces of the housing.

FIG. 5 is a cross-sectional view of a fourth embodiment of the present invention showing one magnetic element attached to a shaft in a housing with a magnetic layer disposed on all of the outside major surfaces of the housing.

FIG. 6 is a graphical representation of the frequency response of the present invention and a prior art pivot bearing.

### DETAILED DESCRIPTION OF THE PREFERRED EMBODIMENT

The preferred embodiments of the present invention are illustrated in FIGS. 2-6. FIG. 2 shows a cross-sectional view of one embodiment of a ferrofluid pivot bearing 10 of the present invention. Ferrofluid pivot bearing 10 includes a shaft 12 having a first magnetic element 14, a second magnetic element 16 and a third magnetic element 18 fixedly attached to shaft 12. Inner bearing elements 20 are fixedly attached to shaft 12 between first, second and third magnetic elements 14, 16 and 18, respectively. Outer bearing elements 22 are also fixedly attached to shaft 12 at the outside surfaces of first magnetic element 14 and third magnetic element 18. First, second and third magnetic elements 14, 16 and 18, inner bearing elements 20 and outer bearing elements 22 each have a cylindrical shape similar in appearance to a disk or a donut.

The shaft 12, magnetic elements 14, 16 and 18, inner bearing elements 20, and outer bearing elements 22 form shaft assembly 30. Shaft assembly 30 is enclosed in a housing 24. The inside dimensions of housing 24 and the outside dimensions of shaft assembly 30 are sized such that a small gap 32′ between the bearing elements 20 and the inside diameter of housing 24 is created, a somewhat larger gap 32 between magnetic elements 14, 16 and 18, bearing elements 22 and the inside diameter of housing 24 is created, and a gap 33 between bearing elements 22 and the ends of housing 24 is created. Gaps 32, 32′ and 33 are not to scale but shown larger than normal for clarity. A magnetic fluid (not shown) is incorporated within housing 24 filling a large proportion of the space defined by gaps 32, 32′ and 33. The viscosity of the magnetic fluid and the magnetic flux density created by magnet elements 14, 16 and 18 generate sufficient stiffness in the pivot bearing 10 to support the head/arm actuator even when the actuator is limited to an angle of approximately 30° as a repetitive movement operation. A layer 28 of magnetic material is optionally disposed around the outside of housing 24. Magnetic layer 28 is generally at least one of nickel, iron and nickel-iron alloy. The magnetic coating reduces the magnetic flux leakage from the pivot bearing

Magnetic elements 14, 16 and 18 have north and south poles and are positioned on shaft 12 such that adjacent magnetic elements have similar magnetic poles facing each other. As illustrated, the south pole end of magnetic element 16 is positioned to be adjacent to the south pole end of magnetic element 14, i.e. creating a repulsive force instead of an attractive force between magnetic elements. This arrangement is important in multi-magnet pivot bearings of the present invention to maintain the proper alignment of magnetic flux fields for use with the magnetic fluid within housing 24 to retain the magnetic fluid's proper position between the magnets and the inside surface of housing 24. It is noted that the magnetic elements 14, 16 and 18 may be inverted so long as all magnetic elements are inverted to maintain the alignment described, i.e. the same magnetic poles are facing each other in adjacent magnetic elements.

Shaft 12 and housing 24 are made of non-magnetic material. Housing 24 is shown as a two-part housing system that has a housing body 25 with a body end flange 26 and a housing end cap 27 for enclosing shaft assembly 30 within housing 24. Body end flange 26 and housing end cap 27 have central openings sized to accept the outside diameter of shaft 12. Inner bearing elements 20 and outer bearing elements 22 are made of magnetic material and further serve as pole pieces, as that term is understood by those skilled in the art of ferrofluid magnetic seals. Optionally, an oil repellent coating (not shown) may be applied to shaft 12 along circumferential areas indicated by reference numeral 34. An oil repellent coating may also be applied to a corresponding circumferential area 36 on the body end flange 26 and housing end cap 27, which is the circumferential area on the inside of the central openings. The oil repellent coating is preferably made of a fluoropolymer material.

An example of preferred dimensions for a ferrofluid pivot bearing of the present invention for use in a 3.5 inch disc drive includes a shaft 12 being about 16.5 mm long with a diameter of about 4.0 mm diameter, magnetic element 16 being about 4.0 mm long with a diameter of about 8.0 mm, magnetic elements 14 and 18 being about 2.0 mm long with a diameter of about 8.0 mm, inner bearing elements 20 being about 1.5 mm long with a diameter of about 8.5 mm, outer bearing elements being about 0.10 mm long with a diameter of about 8.0 mm. The inside diameter of housing 24 is about 8.5 mm and the inside distance between body end flange 26 and housing end cap 27 is about 11.24 mm. It is preferable that gap 32′ formed is about 7 micrometers to about 16 micrometers, or, in other words, the difference between the inside diameter of housing 24 and the outside diameter of inner bearing elements 20 is about 14 micrometers to about 32 micrometers. It is also preferable that gap 33 between outer bearings 22 and body end flange 26 and housing end cap 27 is about 20 micrometers. It is understood by those skilled in the art that these dimensions may be different for disc drives of different sizes such as 1 inch, 1.8 inch and 2.5 inch disc drives and that the determination of these dimensions are well within the ability of those skilled in the art without undue experimentation.

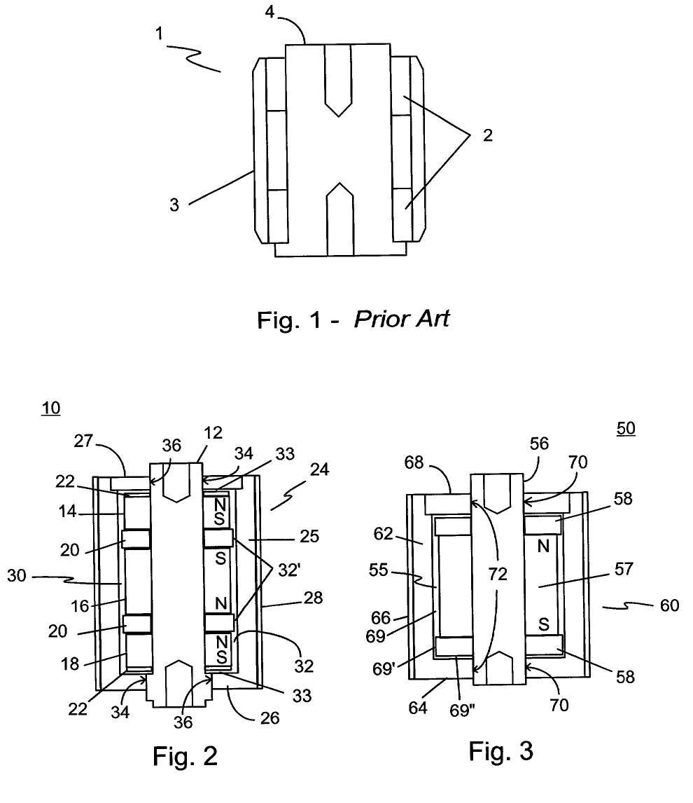

Turning now to FIG. 3, there is shown another embodiment of the present invention. Ferrofluid pivot bearing 50 includes a shaft assembly system 55 enclosed in a housing system 60. Shaft assembly system 55 includes a shaft 56, a first magnetic element 57 attached to shaft 56, and a pair of outer bearing elements 58. Outer bearing element 58 is made of a magnetic material while shaft 56 is made of a non-magnetic material. The outer bearing elements 58 and magnetic element 57 are sized to create gaps 69, 69′ and 69″. Unlike the outer bearing elements 22 in the embodiment illustrated in FIG. 2, outer bearing elements 58 are sized to provide a gap 69′ between the outer bearing elements 58 and the inside diameter of housing 24 like that of gap 32′ in FIG. 1.

Housing system 60 includes a housing body 62 with a body end flange 64 and a magnetic layer 66 disposed around the circumference of housing body 62. Housing end cap 68 is fitted to the open end of housing body 62 to enclose shaft assembly system 55 within housing system 60. As in the first embodiment, a magnetic fluid (not shown) is added to pivot bearing 50. This embodiment of the present invention may also have an oil repellent coating around the circumference of shaft 56 in designated area 70 as well as a coating around the inside surface 72 of the openings in the housing end flange 64 and the housing end cap 68.

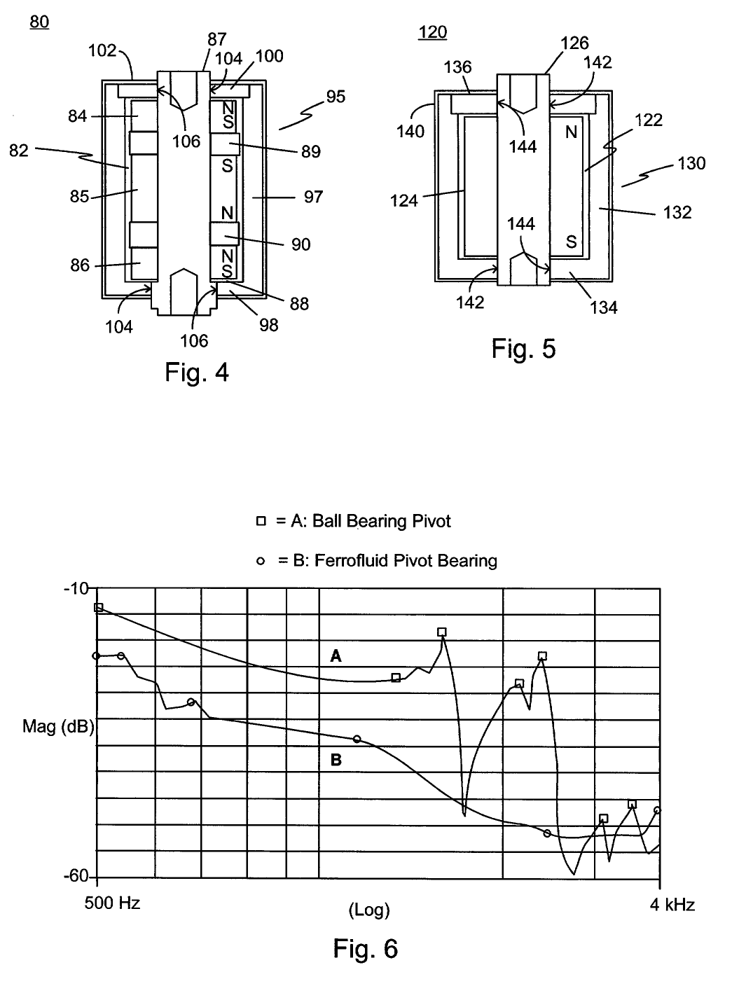

FIG. 4 illustrates a third embodiment of the present invention showing a ferrofluid pivot bearing 80 of the present invention. Pivot bearing 80 includes a shaft assembly 82 and a housing assembly 95. Shaft assembly 82 includes a first magnetic element 84, a second magnetic element 85 and a third magnetic element 86 attached to a shaft 87. Between magnetic elements 84, 85 and 86 are inner bearing elements 89 and 90, respectively. Inner bearing elements 89 and 90 are made of a magnetic material, which also act as pole pieces. Unlike the embodiment illustrated in FIG. 2, ferrofluid pivot bearing 80 does not have any outer bearing elements.

Housing assembly 95 includes housing body 97 with a body end flange 98, and a housing end cap 100 for enclosing magnetic elements 84, 85 and 86, and inner bearing elements 89 and 90. Housing assembly 95 also contains magnetic fluid (not shown) between the magnetic elements, the inner bearing elements and the inside diameter of housing assembly 95. A magnetic layer or coating 102 is disposed on all major outside surfaces of housing assembly 95 including body end flange 98 and housing end cap 100. Pivot bearing 80 optionally has an oil repellent coating around the circumference of shaft 87 in an area designated by reference numeral 104. An oil repellent coating may also be disposed along an area of the opening in body end flange 98 and housing end cap 100 designated by reference numeral 106. The main difference between the embodiments in FIGS. 2 and 4 is the absence of outer bearing elements in the embodiment in FIG. 4 and the extent of the coverage of the magnetic layer or coating. Any combination of the use of bearing elements and magnetic layer coverage may be used. In FIG. 4, magnetic elements 84 and 86 act as the outer bearing elements and, thus, are sized to provide a gap 88 between magnetic elements 84, 86 and the ends of housing assembly 95.

FIG. 5 illustrates a fourth embodiment of the present invention and is the simplest and least expensive to manufacture in terms of material and labor. Ferrofluid pivot bearing 120 includes a shaft assembly 122 and a housing assembly 130. Shaft assembly 122 includes a magnetic element 124 attached to a shaft 126. Housing assembly 130 includes a housing body 132 having a body end flange 134, and a housing end cap 136 for enclosing magnetic element 124 within housing assembly 130. A magnetic layer or coating 140 is disposed on all major outside surfaces of housing assembly 130 including body end flange 134 and housing end cap 136. Pivot bearing 120 may optionally have an oil repellent coating along an area of shaft 126 designated by reference numeral 142. An oil repellent coating may also be disposed along an area of the opening in body end flange 134 and housing end cap 136 designated by reference numeral 144. A magnetic fluid (not shown) is contained within housing assembly 130 and captured between the outside surface of magnetic element 124 and the inside surface of housing assembly 130. Magnetic element 124 also acts as the bearing element in ferrofluid pivot bearing 120.

The choice of embodiments to use is driven by factors such as ease of manufacture, cost of manufacture and pivot bearing performance. Applications where ease and cost of manufacture are critical, embodiments illustrated in FIGS. 3 and 5 are preferred. Applications where pivot bearing performance such as bearing stiffness is the guiding characteristic, embodiments illustrated in FIGS. 2 and 4 are preferred.

FIG. 6 illustrates a comparison of frequency response of the ferrofluid pivot bearing of the present invention (B) and the ball bearing pivot of the prior art (A). As can be seen from FIG. 6, the ball bearing pivot (A) exhibits frequency peaking while the present invention (B) provides relatively peak-free response. The graph shows that vibration generated by the ferrofluid pivot bearing of the present invention is very much lower than that of the ball bearing pivot. It is the high damping effect provided by the viscosity of the ferrofluid as well as the levitation force provided by the magnetic flux density of the magnetic element(s) that reduces frequency wave peaking of repetition movement up to several kilohertz.

As discussed previously, the major advantages of the present invention are contamination control, high damping effect, noiseless performance, and its non-fretting characteristic. Using the magnetic flux force (i.e. the force responsible for the levitation phenomenon) combined with the magnetic fluid as the bearing shaft support in a ball bearing-less pivot bearing has not heretofore been provided.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A ferrofluid pivot bearing comprising:
a shaft;
a first magnetic element fixedly attached to said shaft forming a shaft assembly;
a housing containing said first magnetic element fixedly attached to said shaft wherein said housing is rotatable about said first magnetic element; and
a quantity of magnetic fluid between said housing and said first magnetic element.

2. The pivot bearing of claim 1 wherein said shaft is non-magnetic.

3. The pivot bearing of claim 1 wherein said housing is non-magnetic.

4. The pivot bearing of claim 1 further comprising a magnetic coating over a least a portion of an outside surface of said housing.

5. The pivot bearing of claim 4 wherein said a magnetic coating covers substantially all of the major surfaces of said outside surface of said housing.

6. The pivot bearing of claim 1 where in s aid magnetic coating contains one or more of nickel, iron, and nickel-iron alloy.

7. The pivot bearing of claim 1 further comprising at least a second magnetic element fixedly attached to said shaft.

8. The pivot bearing of claim 7 further comprising an inner bearing element fixedly attached to said shaft between said first magnetic element and said at least a second magnetic element.

9. The pivot bearing of claim 8 wherein said inner bearing element is made of a magnetic material.

10. The pivot bearing of claim 1 further comprising an outer bearing element adjacent said first magnetic element and an end of said housing.

11. The pivot bearing of claim 10 wherein said outer bearing element is made of a magnetic material.

12. The pivot bearing of claim 1 further comprising a ferrofluid-repellent coating on a portion of said shaft corresponding to the ends of said housing.

13. The pivot bearing of claim 1 further comprising a ferrofluid-repellent coating on a portion of said housing located at the ends of said housing adjacent to said shaft.

14. A ferrofluid pivot bearing comprising:
a shaft;
a first magnetic element concentrically and fixedly attached to said shaft;
a housing having a first end and a second end, said first end and said second end having a central opening sized to receive said shaft, said housing containing said first magnetic element fixedly attached to said shaft wherein said housing is rotatable about said first magnetic element; and
a quantity of magnetic fluid within said housing.

15. The pivot bearing of claim 14 wherein said shaft is non-magnetic.

16. The pivot bearing of claim 14 wherein said housing is non-magnetic.

17. The pivot bearing of claim 14 further comprising a magnetic coating over at least a portion of an outside surface of said housing.

18. The pivot bearing of claim 17 wherein said magnetic coating covers substantially all of the major surfaces of said outside surface of said housing.

19. The pivot bearing of claim 14 wherein said magnetic coating contains one or more of nickel, iron, and nickel-iron alloy.

20. The pivot bearing of claim 14 further comprising at least a second magnetic element fixedly attached to said shaft.

21. The pivot bearing of claim 20 further comprising an inner bearing element fixedly attached to said shaft between said first magnetic element and said at least a second magnetic element.

22. The pivot bearing of claim 21 wherein said inner bearing element is made of a magnetic material.

23. The pivot bearing of claim 14 further comprising an outer bearing element adjacent said first magnetic element and said first end of said housing.

24. The pivot bearing of claim 23 wherein said outer bearing element is made of a magnetic material.

25. The pivot bearing of claim 14 further comprising a ferrofluid-repellent coating on a portion of said shaft corresponding to said first end and said second end of said housing.

26. The pivot bearing of claim 14 further comprising a ferrofluid-repellent coating on a portion of said housing located at said first end and said second end of said housing and adjacent to said shaft.

27. A method of making a ferrofluid pivot bearing comprising:
obtaining a non-magnetic shaft;
fixedly attaching a first magnetic element to said non-magnetic shaft wherein said magnetic element is concentric with said shaft;
forming a housing for containing said first magnetic element wherein said housing is rotatable about said first magnetic element;
placing said first magnetic element and said shaft within said housing such that said first magnetic element is enclosed within said housing; and
adding a quantity of magnetic fluid to said housing sufficient to form a ferrofluid magnetic seal between said first magnetic element and the inside surface of said housing.

28. The method of claim 27 further comprising coating a ferrofluid repellent material onto an area of said shaft adjacent to the ends of said housing.

29. The method of claim 27 further comprising coating a ferrofluid repellent material onto an area of said housing ends opposed to the circumference of said shaft.

30. The method of claim 27 further comprising disposing a conductive layer over the outside circumferential surface of said housing.

31. The method of claim 30 wherein said disposing step includes disposing said conductive layer over substantially all of the major outside surfaces of said pivot bearing.

32. The method of claim 27 further comprising fixedly attaching at least a second magnetic element to said shaft, said at least a second magnetic element positioned to be enclosed within said housing.

33. The method of claim 32 further comprising fixedly attaching an inner bearing element to said shaft between said first magnetic element and said at least a second magnetic element.

34. The method of claim 27 further comprising fixedly attaching an outer bearing element to said shaft adjacent to said first magnetic element and an end of said housing.

35. The method of claim 27 wherein said housing forming step includes sizing the inside diameter of said housing for receiving said first magnetic element to provide a gap between the inside surface of said housing and the outside diameter of said first magnetic element sufficient for using the magnetic flux field created by said first magnetic element to support rotational movement of said housing relative to said first magnetic element.

36. The method of claim 27 wherein said housing forming step includes sizing the inside diameter of said housing for receiving said first magnetic element to provide a gap between the inside surface of said housing the outside diameter of said first magnetic element sufficient to form said ferrofluid magnetic seal when said magnetic fluid is added to said housing.

37. A method of making a ferrofluid pivot bearing, said method comprising:
using the magnetic flux field of at least a first magnetic element concentrically mounted to a shaft and contained within a housing having a quantity of magnetic fluid therein, said magnetic flux field and said magnetic fluid supporting rotational movement between said housing and said shaft.

38. The method of claim 37 further comprising attaching a bearing element to said shaft adjacent to said at least a first magnetic element, said bearing element being made of a magnetic material.

39. The method of claim 37 further comprising attaching at least a second magnetic element to said shaft such that said at least a second magnetic element is contained within said housing, said at least a second magnetic element being used to support rotational movement of said shaft.

40. The method of claim 39 further comprising adding an inner bearing element between said at least a first magnetic element and said at least a second magnetic element, said inner bearing element being made of a magnetic material.

41. The method of claim 37 further comprising disposing a magnetic material over the outside circumferential surface of said housing.

42. The method of claim 37 further comprising disposing a magnetic material over all of the major outside surfaces of said housing.

43. A method of using the magnetic flux field of a magnet as the support mechanism for a pivot bearing, said method comprising:
forming a housing for receiving a shaft assembly;
forming said shaft assembly wherein said shaft assembly has a shaft and at least one magnetic element fixedly attached to said shaft;
inserting said shaft assembly into said housing; and
adding a quantity of magnetic fluid to said housing.
